(19) United States
(12) Patent Application Publication
(10) Pub. No.: US 2002/0008068 A1
(43) Pub. Date: Jan. 24, 2002

(54) APPARATUS AND METHOD FOR BACKWASHING FLUID FILTER SYSTEMS

(76) Inventor: GARY LINDSAY ANDERSON, WILLOUGHBY (AU)

Correspondence Address: ABELMAN FRAYNE & SCHWAB, 150 EAST 42ND STREET, NEW YORK, NY, 100175612

(21) Appl. No.: 08/952,420

(22) PCT Filed: May 15, 1996
(86) PCT No.: PCT/AU96/00295

(30) Foreign Application Priority Data
May 15, 1995 (AU) PN 2959

(51) Int. Cl. C02F 1/00

(52) U.S. Cl. 210/741

(57) ABSTRACT

A filtering apparatus (10) includes a filter chamber (12), a hollow filter screen (18) within the filter chamber (12), inlet means (11) for admitting fluid to be filtered to the chamber (12) on the outside of the filter screen (18), and a backflush assembly (49) within the filter screen (18) adapted to spray backflush fluid to the inner surface of the filter screen (18).

### TECHNICAL FIELD

This invention relates to a filter assembly and in particular to an improved fluid filter assembly including a spray manifold assembly which enables the screen to be backwashed from its interior.

### BACKGROUND ART

Conventional filter arrangements have been known wherein a backwash device is provided proximate an inlet side of a filter element in the filter arrangement. For instance, U.S. Pat. No. 4,085,051 to Kaminsky et al discloses a self-cleaning filter for separating solid particles from a liquid wherein a device for backwashing the filter element abuts the filter element and is rotated about a central shaft such that the filter element can be backwashed of any accumulated particles. However, the backwashing function requires a pressure differential between an inlet chamber and an outlet chamber of the filter apparatus due to the buildup of particulate matter on the inlet side of the filter elements.

The necessary pressure differential further requires the presence of a substantial amount of filtered fluid in the outlet chamber. Filtered fluid must be present at an outlet side of the filter to provide a liquid medium passing in a reverse direction through the filter to transport the particulate matter from the inlet side of the filter and into the backwashing device. However, such filtered fluid is not always present at the outlet side in the Kaminsky et al device. When filtering fluids have particles of a broad particle size distribution, it is inevitable that the filter element will become clogged before there is a sufficient amount of filtered fluid in the outlet chamber to facilitate the backwashing function.

U.S. Pat. No. 3,635,348 to Carr discloses an automatic self-cleaning strainer which provides a backwash device in abutted contact with an inlet side of a filter element in the strainer. The filter element is shaped like a truncated cone and the shape of the contacting surface of the backwash device is complimentary to the inlet side of the filter element. The backwash device is retractable along a central axis of the filter element to facilitate sequential radial movement of the backwash device within the filter element. This strainer apparatus cannot provide continuous backwashing due to the sequential action of the backwash device. As a result, the efficiency of the strainer apparatus is degraded.

The Carr strainer apparatus also appears to suffer from the problem encountered in the filter apparatus of Kaminsky et al, in that the backwashing function is contingent upon whether the outlet chamber is filled with filtered fluid, i.e., whether filtered fluid is present proximate an outlet side of the filter element. Accordingly, the strainer apparatus of Carr cannot filter fluid mediums having a broad particle size distribution including ultrafine particles, since it is inevitable that the filter element will become clogged before the outlet chamber is filled with filtered fluid to facilitate the backwashing function.

U.S. Pat. No. 3,640,395 to Kinney discloses an automatic self-cleaning strainer having a plurality of filter stages including backwash devices in loose contact wit an inlet side of the filter elements of each filtering stage. Each of the backwashing devices is in communication with a hollow shaft which is open to the atmosphere. It would appear, however, that before the backwashing function will occur, filtered fluid must be present in the outlet chambers of each filtering stage. Hence, the strainer apparatus cannot filter a fluid medium which contains large amounts of particulate matter including ultrafine particles, since the filter elements in each stage will become clogged before the outlet chambers are filled with filtered fluid to facilitate the backwashing function.

U.S. Pat. 3,669,269 to Kinney discloses a filter apparatus having a rotating cylindrical strainer element and a stationary backwash chamber in contact with an inlet side of the strainer element. However, it appears that in this device, the outlet chamber within the strainer element must be 30 substantially full of filtered fluid before the backwashing function will occur. Depending on circumstances, this does not necessarily always occur in the device.

Examples of filter assemblies incorporating a plurality of tubular filter means suspended in a housing and closed at both top and bottom include U.S. Pat. Nos. 2,954,873, 3,169,109, 3,228,528 and 3,346,215. U.S.

Pat. No. 4,781,825 sought to improve on the above methods by means of a rotating backwash selector which was rotated by the backwash fluid so as to cause a sequential exposure of the backwash fluid to the filters. In such types of filter assemblies the filters are suspended from a partition dividing the housing into a lower inlet portion and an upper outlet portion, so that the fluid flows from inside the filter through the perforated partition to the upper outlet portion. The solids remain on the outside of the tubular filter. Due to eventual heavy accumulation of solids on the outside of the filter means, it is necessary to backflush the filter. The media in these systems is a bed of sand or gravel or like material. The backflushing in such systems involves flowing backflush fluid in a reverse direction through the filter. The above systems involve simultaneous backflushing of the filter assemblies.

Recent trends in filter design have involved systems incorporating back-washable cylindrical screen filter systems. In such systems the liquid flows radially outwards from the centre of the cylindrical screen during filter mode. Backflushing of these systems is achieved by means of suction ports on a manifold rotating on the inside of the cylindrical screen and over the length of the cylindrical screen. The suction ports are actuated on a timer or pressure differentially controlled basis through the action of opening of a drain valve to atmospheric pressure generating a negative pressure on the inside of the screen. This negative pressure causes the liquid to flow from the clean side of the screen resulting in the action of breaking up the filter cake causing it to disintegrate into smaller particles which are carried along by the flow of liquid.

The abovementioned prior art systems are normally effective to degrees of filtration of the order of 40 microns and in some cases to the order of 25 microns, but a common problem with these assemblies is the requirement of considerable quantities of water necessary for the system to achieve effective backflushing. For example on a 3 inch N.B. cylindrical screen filter the quantity of backflush water would be of the order of 100 litres which is a considerable quantity of water. the reason for this is that the actual power of water backflush flow within the system is reduced by the fact that filtering flow continues during backflush so the final pressure operating through the screen during backflush is far less than it is in the present invention.

### SUMMARY OF THE INVENTION

The invention provides an apparatus and method for minimising the volume of backflush and simultaneously providing the flexibility to modify and integrate the filter/backflush/concentrate functions on an individual application basis.

The invention provides an apparatus and method of filtering and filter screen backwashing in which the flow of liquid during filtering operates in a generally radially inward direction from the outside of the screen, and whereby the backflush flow is directed in a generally radially outward direction from the inside of a cylindrical filter screen to the outside of the filter screen.

In one embodiment of the invention, the improved filtering and backwashing apparatus and method incorporates a fluid sealed rotating spray manifold assembly positioned inside the cylindrical filter screen to spray the backwash liquid radially outwardly to the filter screen in order to effectively clean the screen of accumulated cake and thoroughly complete the backwash. By means of the application of electrical timer controls, solenoid valves, a variety of speed motors, and pumping configurations, the most effective control sequence can effectively be implemented by a person skilled in the art of filter and engineering technology. Hence, the operations of filtering and improved backwashing according to the invention can be adjusted and modified to suit a particular individual filtering application in order to achieve the most efficient system for that corresponding application. For example, the diversified range of filter applications include cooling water, pharmaceutical process solutions, boiler feedwater, salt water, refinery processes, solvent filtering in dry cleaning operations, and other miscellaneous applications of a commercial or industrial nature such as waste water or effluent re-use.

The invention further provides an improved method of structuring the filter housing and associated water flow through the filter to achieve a highly improved and effective system for backflushing the screen. This is achieved by having the flow of water during filtering being down with the outlet of the filtered water room the filter chamber being below the screen. further, the allowance in the design for a settlement chamber below the screen coupled with the controlled sequence of backflush spray on the screen while normal filtering mode is in operation (i.e. not requiring the drain valve to be open) causes the sediment collected on the screen to be moved by the action of the backflush spray in combination with the general flow of water over, around and through the scren during filtering mode, into the collection chamber. Through the programmed cycles of what is termed “settlement flush” the concentrated sediment/sludge is collected in the collection chamber. This can be eliminated from the chamber under pressure with minimal water loss by opening the collection chamber flush input valve in combination with opening the collection chamber drain valve. In simplified terms, this design enables the screen to be flushed clean many times without the requirement to either take the filter off line or open the drain valve.

The invention further provides an apparatus for filtering and filter screen backwashing comprising a filter chamber, a hollow filter screen assembly situated within the filter chamber, mans for entry of unfiltered fluid to the filter chamber and outside the filter screen assembly, means for causing the flow of the unfiltered fluid to operate in a generally radially inward direction from the outside of the filter screen, a backlash manifold assembly disposed axially of the filter screen assembly, and comprising a plurality of spray outlets adapted to spray backflush liquid in a radially outward direction to the inner surface of said filter screen assembly.

The filtering and backwashing apparatus preferably incorporates a sealed axially rotatable spray manifold assembly positioned inside said filter screen. The manifold assembly is adapted to spray the backwash liquid radially outwardly to the filter screen in sufficient quantity and force to effectively clean the screen of accumulated cake and thoroughly complete the backwash.

The screen assembly is preferably of a generally cylindrical shape and the manifold is positioned substantially axially of the cylinder and is capable of rotating axially in at least one direction, either continually or intermittently. The spray outlets preferably consist of a series of jets positioned along at least part of the shaft of the manifold. The jets may be positioned in a generally spiral configuration or in some other suitably designed arrangement.

The apparatus may further include a filter supply pump with a variable speed motor drive, means or measuring liquid flow rates, the motor drive being responsive to the flow rate measuring means and adapted to reduce the flow and pressure into and within the filter during one or more flushing cycles in drain close mode.

The apparatus may incorporate a variable speed drive on the backflush adapted to vary the pressure on the spray outlets, responsive to various parameters and controlled by the controller.

The invention further provides an apparatus for filtering and filter screen backwashing comprising a filter chamber, a sealed cylindrical filter screen assembly situated within the filter chamber, means for entry of unfiltered fluid to the filter chamber and outside said filter screen assembly, means for causing the flow of said unfiltered fluid to operate in a generally downward and radially inward direction from the outside of the filter screen, a backflush manifold assembly disposed within said filter screen assembly, and comprising a plurality of spray outlets adapted to spray backflush liquid in a radially outward or outward and downward direction to the inner surface of the filter screen assembly, and further including a controller, a variable speed pump, and a collection chamber with a drain at the lower end of the filter chamber.

The apparatus preferably includes an operable drain such that there exists a drain open mode and a drain closed mode, the collection chamber being situated at or near the lower end of the filter chamber, means for causing or allowing a downward flow of water through the filter, means for causing the spray outlets to operate in either an on position or an off position, the period of said on position being known as a flushing cycle, the downward flow and the spray outlet being capable of removing the filter cake from the screen and storing and concentrating said filter cake in the collection chamber, and means for performing one or more finishing cycles during the drain closed mode.

According to the invention there is also provided a method of backflushing a filter, including the steps of programming a controller means to recognise a preset pressure differential threshold, initiating a backflush mode when the threshold is attained, reducing the pressure automatically during backflush mode, and opening a drain flush under the control of the controller.

The inventor has found through research and design and use of the new method and apparatus as described herein, and with the same cylindrical screen filter (3 inch N.B.) the quantity of water necessary for backflush is only of the order of 3 to 4 litres. A further advantage of the settlement flush process to be discussed later means that up to 25 flush cycles or more can be carried out before the intermittent pressurised flush needs to be activated. Therefore the overall advantage is the water used for flushing purposes is reduced by more than 90% or stated in other terms, less than 1% of the water is required to be used for flushing purposes.

The filter assembly according to the present invention is capable of operating with a higher pressure differential across the screen before a backflush is initiated. Therefore more cake is held on the screen before backflush so the advantages are even more pronounced. The total advantage in water economy will vary with the application, but with an estimate of 50% more cake with double the pressure differential, combined with the backflush quantity advantage gives the system a final comparative backflush water consumption of less than 1 % of traditional screen systems. With the growing concern in recent times for water conservation in addition to monetary considerations of excess usage of water resources, the new filtering and backwashing arrangement according to the invention represents a valuable advantage to operators involved in commercial and industrial applications involving filtering processes.

In a preferred form of the present invention water flow through the filter is suspended when a drain flush is initiated and the spray manifold applies a focalised pressure spray to a relatively small area of the circumference of the screen. When the spray manifold is rotated the spray covers the whole screen. Thus during drain-open backflush there is no resistance to the backflush flow. A primary advantage of this is the ability to focus more power in the backflush stream to the screen so that more tightly packed cake (higher pressure differential across the screen) can be removed with far less water.

### BRIEF DESCRIPTION OF THE DRAWINGS

FIG. 1 is a perspective view of a manually operated filter system including controls and various features and components thereof according to one embodiment of the invention.

FIG. 2 is an expanded view of the backflush manifold and filter screen, FIG. 3 is a cut away front elevational view of an embodiment of the filter design using a settlement chamber.

### MODES FOR CARRYING OUT THE INVENTION

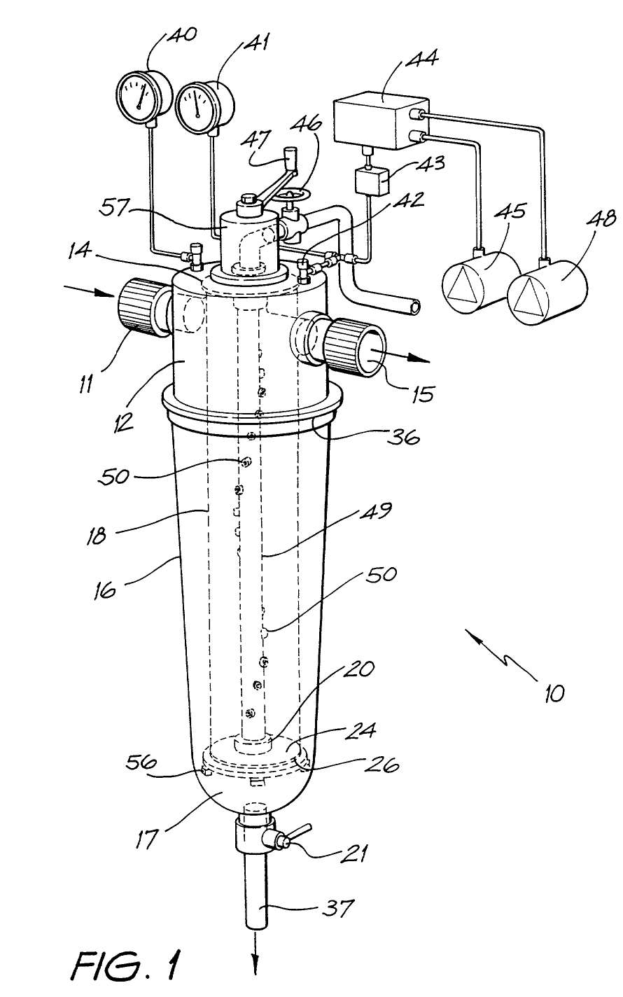

Referring to FIG. 1 which depicts a perspective view of a manually operated filter system 10, water to be filtered enters port 11 and into inlet chamber 12 of the filter head assembly 14, into the filter bowl 16 to the outside inner wall and down to the concentrate collection chamber 17. Filtrate is drawn off through outlet 15. The control valve 21 is opened during the backflush mode to release the particulate concentrate to drainage port pipe 37. Control valve 21 is a manually operated valve in the semi-automatic version of the invention and an electrically powered valve, hydraulically controlled valve or a compressed air powered valve in the fully automatic version of the invention.

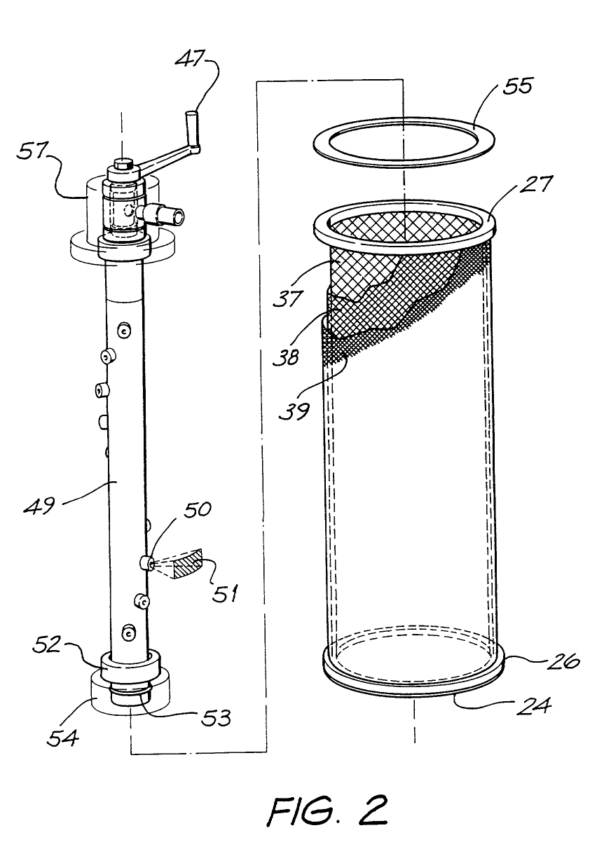

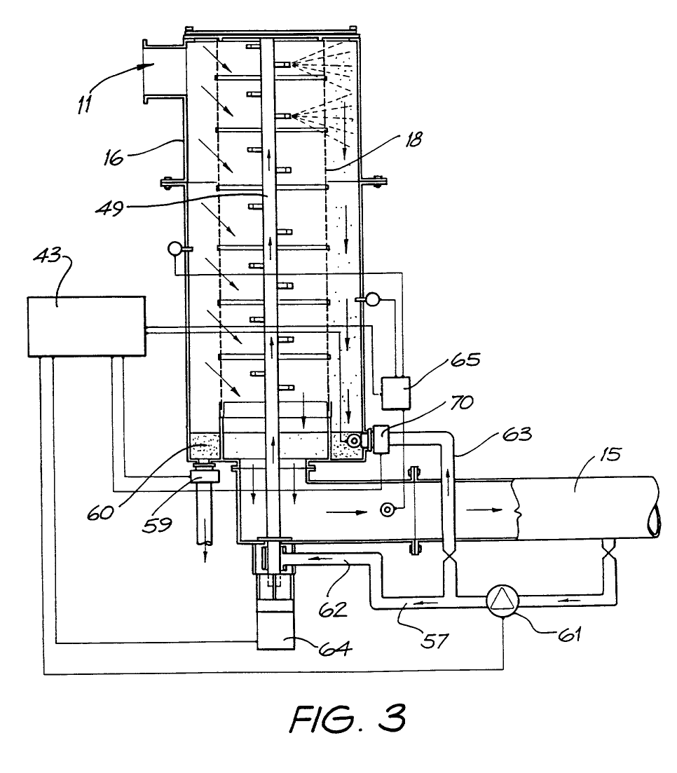

Screen assembly 18 comprises a finest screen with coarser structural support screens layered adjacent to provide a sturdy and consistent barrier to the flow of water, with the fine screen on the outside being the first surface to receive the water flow. As shown in FIG. 2 there is a fine screen 39, a medium screen 38, and a coarse screen 37. These are held in place by the support rings 26 and 27 and a plate 24 which serves as a strengthener for the cylindrical shape of the screen. Alternatively two layered screens can be used in some applications. Also a further prefiltration layer can be placed outside the fine screen to give a layered surface for both filtration cake buildup and backwash flow.

As the water flows through the screen a progressively open and rounded surface greets the water. This ensures a readily backwashable maze for example if the fine screen is 45% open area, the medium screen may e 50-55% with the coarse screen 60% plus. As an alternative, a coarser layer of screen material can be placed on the outside of the fine screen to have an integrated two stage filter where both screens can be backflushed simultaneously. Concurrent with the design of maintaining a readily backwashable maze the refiltration layer would be around 55-60% open area.

As the filtrate passes through the screen 18 and solids build up on the screen 18 a pressure drop occurs across the screen 18. The pressure at the inlet of the filter head is measured and displayed by the gauge 40 through the inlet pressure port. The pressure at the outlet of the filter head is measured and displayed by the gauge 41 through the outlet pressure port 42 with attached fitting. The pressure switch 43 monitors the outlet pressure and at a presettable and variable pressure sends a signal to the controller 44. The controller in the semi-automatic system will then send alarms if required and switch off the supply pump if required.

The operating parameters of the filter used herein according to the invention are preferable to those of the traditional style of backwashable screen filters where in the cake is sucked off the screen. For instance, up to this point screens to 25 micron required a minimum of 350 kpa line pressure to backflush effectively. With the present invention the backflush stream operated independently of the flow through the filter. Therefore a line pressure of 100 kpa is an adequate pressure. The backflush pump is sized to deliver in the standard version but the facility is inherent in the design to utilise high pressure backflush to 100 kpa as required by the particular installation. It is far more economical to increase the pressure of the low volume backflush line that it is to increase the pressure in the supply line.

Once the supply inlet flow is cut off either by the turning of the control inlet valve to the filter or the switching off of the supply pump 45, the filter system is in rest mode. In the semi-automatic version it is now ready for the operation of the backflush mode and the following procedure is performed.

1. Drain valve 21 is opened to release concentrated particulated fluid to discharge pipe 37.

2. Backflush supply control valve 46 is opened to supply pressurised and filtered water from the outlet side of the filter.

3. Backflush rotation handle 47 on the rotating seal assembly 57 is rotated once or more depending on the installation. This then rotates the spray backflush manifold to clean the full surface of the screen with a focalised pressure and with the use of rotation provides a thorough clean of the complete screen.

4. Once backflush is complete drain valve 21 is closed and the valves and/or pumps are reset for filter operation, for systems installed with supply pump 45 a backflush pump 48 is also installed. For mains pressure systems, valving can be utilised to use mains pressure for backflush supply using a filter cartridge to filter the backflush stream. For the fully automatic version the controller controls an electrically powered valve, hydraulically controlled valve or a compressed air powered valve as drain valve 21. The backflush rotation handle 47 is replaced by a motor and energy supply which can be controlled as to the time and number of rotations.

When required for specific applications, the motor and drive can be changed to give a faster or slower rotation or a variable or multiple speed to suit the requirements of the specific installation. Programmable into the filter and backflush operation is the application of short bursts or pulses of pressurised backflush water either with drain valve 21 open or closed. The purpose of this is to utilise the ability of the cake on the screen to congeal small particles into masses which will to a greater or lesser degree act as larger particles and sink as units to the collection chamber 17.

This ability for each user of the product to modify and custom design the filter operation is novel and very practical as particulate required to be filtered vary tremendously in the way they develop a cake on a filter screen. In addition, the properties of the cake itself can vary greatly.

During backflush mode the backflush supply manifold 49 rotates to clean the entire surface of the screen by blowing the cake off the screen and radially outward towards the wall of the filter chamber 16. The sprays 50 and the rotation are designed to give maximum coverage of he screen with the highest pressure. This is achieved by using narrow jet sprays mounted close to the inside surface of he screen. These jets cover a small rectangular area of the screen giving a focalised pressure jet to the surface of the screen which becomes a total screen coverage as a backflush arm is rotated. The area of coverage of a single spray jet with a stationary backflush arm is shown at 51.

The backflush arm rotates in the bottom bearing 52 which includes an o-ring seal 53 and a fixing cap 54. This bearing is mounted to the filter screen base 24. The filter screen is sealed over its full surface. Gasket 55 seals the water flow from bypassing at the top of the screen. The screen is sized appropriately so that with the pressure of the screen/housing supports 56 pressured is applied to the top gasket to create a pressure seal.

In the embodiment of FIG. 3, water to be filtered enters the inlet port 11. The water is directed to flow to the outside of the filter chamber as it flows into the body of the filter. With the filter screen 16 as a semipermeable barrier all water entering the filter chamber must exit through the screen, i.e. except when drain is open. The general direction of flow while filtering is shown as the arrows pointing diagonally on the left of the screen pointing through the screen. Once a preset differential is reached as measured by switch 65, the process of settlement flush is initiated where filtered water supply from the outlet of the filter is pumped by pump 61 into the backflush spray manifold 49 which is rotated by motor 64 via the backflush supply pipe 57 and line 62 Line 63 directs backflush water into the collection chamber 60. The centre of direction of flow of the sprays is shown on the diagram as horizontal, although these spray heads could be mounted so that the direction of spray is slightly (10-20 deg) downwards. As the filtered water is sprayed through and away from the screen the flow of the unfiltered water will cause the sediment to slowly move down the outside of the screen and settle in the collection chamber 60. This is indicated by the illustration on the right of the screen. The period of settlement flush can be varied by the controller to suit the flow rate and the nature of the solids being filtered. At the end of the settlement flush the screen will be clean and the solids will have been moved from the screen to the collection chamber by this combination of flows. The cycle of settlement flushes can continue until the solids have settled to a degree where a lush of the collection chamber s required. The number of settlement flushes before chamber flush is initiated can be carried by the controller to suit the application. The flush of the collection chamber is achieved by simultaneously injecting filtered water into the collection chamber through the inlet port 11, and opening the drain port 59 while the filter is pressurised. The time the drain port is open is variable from the controller with the adjustment able than to limit the amount of flush water to that only required to empty the settlement chamber 60.

It is preferable to have a collection chamber manifold with sprays so a to maintain a substantially uniform distribution or concentration of sludge in the collection chamber 60. The action of these sprays serves to prevent local buildup or caking in this area. The steady flow of sludge is also enhanced as a result o this action.

If required, a full drain flush can be initiated periodically to give the screen an extra clean and flush the collection chamber completely but under normal filter/concentrator action the sludge is removed effectively. This filter is considered to be an improvement over the prior art since it includes the following novel features:

1. The backflush spray is directed from inside the screen.

2. Spray cleaning of the outside of the screen takes place without loss of water or shutdown of the filter operation.

3. The apparatus incorporates a pressurised sediment collection chamber.

4. The system including the backflush may further operate with the use of one or more variable speed drives.

The combined advantage of all the practical designs and reasons for the filter effectiveness add up to a single piece of equipment that can filter water and remove the sediment as a concentrated sludge during pr simultaneously with the filter process. This is not achieved in prior art filter systems.

The invention can be applied to filter assemblies and in particular to an improved fluid filter assembly including stainless steel or meshed screens formed from materials such as nylon, or any other materials known to those skilled in the art. The invention could apply to filtering of contaminated water, sewage treatment plants, well water, dams, irrigation systems, waste oil from industry, drill oil, air-conditioning and other filters. In fact, any suitable screen may be used in the device, including filters having variable porosity such as an increasing porosity from inlet side to outlet side.

While certain embodiments and details have been shown for the purpose of illustrating the present invention, it will be apparent to those skilled in the art that various changes and modifications may be made without departing from the spirit and scope of the invention.

### INDUSTRIAL APPLICABILITY

The present invention provides a filter and backwashing system which can filter to a high level of filtration and is required in many commercial and industrial applications, such level of filtration being at least in the range of 15-25 microns or even lower (1-15 microns) if required for specific applications. The filter system according to the invention is further capable of operating with a significantly lower volume of water for backflushing in comparison to prior art filtering and backwashing systems.

The invention also provides a filter and backwashing system having the capability for each user of the product to modify and custom design the filter operation. Achieving this is very practical since particulates required to be filtered vary diversely not only in the properties of the filter cake but also in the manner in which the cake is developed on a filter screen.

1. Apparatus for filtering and filter screen backwashing comprising:(i)
(i) a filter chamber,
(ii) a hollow filter screen assembly situated within the filter chamber,
(iii) an inlet to the filter chamber for introducing unfiltered fluid into the filter chamber and onto the outside of the filter screen assembly,
(iv) an outlet for discharging filtrate from within the filter screen assembly,
(v) a solids collection chamber beneath the filter screen assembly for collecting solids filtered by the filter screen assembly,
(vi) a normally closed drain outlet for periodically discharging solids from the solids collection chamber,
(vii) a backflush manifold assembly disposed within the filter screen assembly, and
(viii) means for periodically delivering backflush fluid to the backflush manifold assembly to effect a backwash of the screen with the drain outlet closed.

2. Apparatus according to claim 1 wherein the backflush manifold assembly is a sealed axially rotatable spray manifold assembly positioned inside said filter screen, said manifold assembly adapted to spray the backwash liquid radially outwardly to the filter screen in sufficient quantity and force to effectively clean the screen of accumulated cake.

3. Apparatus according to claim 1 wherein said screen assembly is of a generally cylindrical shape and said manifold is positioned substantially axially of said cylinder and is adapted to rotate in at least one direction, either continually or intermittently.

4. Apparatus according to claim 1 wherein said spray outlets consist of a series of jets positioned along at least part of a hollow shaft of said manifold.

5. Apparatus according to claim 4 wherein said jets are positioned in a generally spiral configuration.

6. Apparatus according to claim 1 wherein the normally closed drain outlet is adapted to operate in a drain closed mode and a drain open mode, wherein the solids collection chamber is situated at or near the lower end of the filter chamber and the inlet is situated at or near the upper end of the filter chamber and wherein the means for periodically delivering backflush fluid to the backflush manifold assembly causes the spray outlets to operate in either an on mode or an off mode, the period of said on mode defining a flushing cycle, the downward flow of the inlet fluid and the flow from the spray outlets being such to remove deposited solids from the filter screen assembly and to direct the deposited solids to the collection chamber, said apparatus further including means for performing one or more flushing cycles during said drain closed mode.

7. Apparatus according to claim 6 further including an unfiltered fluid supply pump with a variable speed motor drive, means for measuring fluid flow rates, said motor drive being responsive to said flow rate measuring means and adapted to reduce the flow and pressure into and within the said filter during one or more flushing cycles in said drain closed mode.

8. An apparatus according to claim 6 including a backflush fluid supply pump with a variable speed drive adapted to vary the pressure of fluid from the spray outlets, said drive being responsive to predetermined parameters.

9. Apparatus according to claim 6 and including a process controller which includes a preset pressure differential threshold, the controller being adapted to initiate a backflush mode when said pressure differential threshold is obtained, means for opening the normally closed drain outlet during the backflush mode and means for controlling the flow of unfiltered fluid to the filter chamber during the backflush mode.

10. A method of operating a filter including the steps of:
(i) introducing unfiltered fluid into a filter chamber having a hollow filter screen assembly therein,
(ii) removing filtered fluid from the filter screen assembly,
(iii) collecting solids in a collection chamber beneath the filter screen assembly, said collection chamber having a normally closed drain outlet,
(iv) periodically flushing the filter screen assembly with fluid directed from within the assembly so as to dislodge any solids deposited on the outside of the hollow filter screen with the drain outlet of the solids collection chamber closed, and
(v) periodically backflushing the solids collection chamber to remove deposited solids therefrom.

11. Apparatus according to claim 9 where in said jets are positioned in a generally spiral configuration and said apparatus includes an inlet flange mounted tangentially to said filter chamber adapted to generate a centrifugal motion of fluid after entry and thereby adapted to cause larger particles to move downwardly in the direction of said collection chamber.

12. Apparatus according to claim 9, wherein the controller means includes a preset pressure differential threshold, said controller initiating a backflush mode when said threshold is attained, a variable peed drive pump adapted to reduce the pressure automatically during backflush mode, drain open flush being operated by the said controller.

13. A method of backflushing a filter, including the steps of programming a controller means to recognise a preset pressure differential threshold, initiating a backflush mode when the threshold is attained, reducing the pressure automatically during backflush mode, and opening a flush drain under the control of the controller.
